(19) United States
(12) Patent Application Publication
(10) Pub. No.: US 2024/0127233 A1
(43) Pub. Date: Apr. 18, 2024

(54) BLOCKCHAIN LOCKING MECHANISM USING PAPER SHARE CERTIFICATE

(71) Applicant: Securrency, Inc., Annapolis, MD (US)

(72) Inventor: George Daniel Doney, Riva, MD (US)

(73) Assignee: Securrency, Inc., Annapolis, MD (US)

(21) Appl. No.: 18/138,455

(22) Filed: Apr. 24, 2023

Related U.S. Application Data
(60) Provisional application No. 63/334,930, filed on Apr. 26, 2022.

(51) Int. Cl. G06Q 20/38; G06Q 20/02

(52) U.S. Cl. CPC G06Q 20/3829; G06Q 20/02; G06Q 20/38215

(57) ABSTRACT

A method for ensuring digital wallet security by implementation of a blockchain locking mechanism operable to prevent unauthorized digital token transfer from an owner digital wallet to a third-party digital wallet upon issuance of a paper token certificate. The blockchain locking mechanism is implemented such that compromise of the digital wallet does not results in unauthorized transfer of digital assets. The blockchain locking mechanism utilizes an unlocking code required to transfer asserts from the owner digital wallet to any third-party digital wallet. The blockchain locking mechanism implements an additional security measure and introduces physical security measures to combat cyber security threats. The paper token certificate assures investors of the safety of their digital assets by removing the vulnerability of having a single private key controlling their digital assets.

### CROSS REFERENCES TO RELATED APPLICATIONS

This application is related to and claims priority to and the benefit of U.S. Provisional Application No. 63/334,930, filed Apr. 26, 2022, which is hereby incorporated by reference in its entirety.

### BACKGROUND OF THE INVENTION

### 1. Field of the Invention

The present invention relates to a locking mechanism to increase the security of digital assets and/or account abstractions by application of a certificate-based lock and a smart contract based locking check.

### 2. Description of the Prior Art

It is generally known in the prior art to provide security measures for maintaining a digital wallet.

Prior art patent documents include the following:

U.S. Patent Publication No. 2020/0202350 for Constraints on outputs of an unlocking transaction in a blockchain by inventors Chan, et al., filed Aug. 24, 2018 and published Jun. 25, 2020, is directed to a trustless deterministic state machines that can be implemented using a blockchain infrastructure and state machines that can run concurrently over more than one blockchain transaction. The transactions can be done in a Bitcoin blockchain ledger. A first set of constraints on a first unlocking transaction output is determined. A second set of constraints on a second unlocking transaction output is determined. An initial transaction is created to include at least one initial locking script that includes the first set of constraints and the second set of constraints and at least one redeemable value, with unlocking the at least one redeemable value being contingent upon the first set of constraints being satisfied, at least in part, by validating that a unlocking transaction includes the first transaction output, and the second set of constraints being satisfied, at least in part, by validating that the unlocking transaction includes the second transaction output. The initial transaction is caused to be validated at a node of a blockchain network

U.S. Patent Publication No. 2022/0222657 for method and system for managing life cycle of a tokenized real asset in a blockchain-based ecosystem by inventor Nichani, filed May 15, 2020 and published Jul. 27, 2022, is directed to a method and system for managing life cycle of a tokenized real asset in a Blockchain-based ecosystem 100. The asset tokens of the real asset are put up for sale on a token issuance platform 118 and the proceeds from the sale are distributed to the asset owner, etc. The listing of asset tokens in the Blockchain-based ecosystem 100 requires project consensus which involves participation of key stakeholders who own utility tokens to participate in the community decision making. The asset tokens are then subjected to trading and maintenance which includes maintaining money flow corresponding to the real asset, selling the asset tokens by the asset token holders via an asset token exchange 808, and settlement of rewards to asset token holders via a settlement engine 810. Upon the end-of-term of the real asset, the asset tokens are terminated, and exit is enabled from the Blockchain-based ecosystem 100.

U.S. Pat. No. 11,361,289 for Distributed cryptographic tokens with downstream administrative control by inventors Housser, et al., filed Feb. 27, 2019 and issued Jun. 14, 2022, is directed to a platform that enables centralized control over updates to a distributed cryptocurrency network through inclusion of an administrative user to a set of tokens that operate on a base cryptocurrency network but include rule sets that are separate from those of the base cryptocurrency. A plurality of customized token types are generated by a platform provider for respective administrative users. The platform provider may provide software updates that are implemented at the sole discretion of the respective administrative users.

U.S. Pat. No. 11,080,689 for Secure processing and transfer of tokens in a distributed chain database by inventors Remeika, et al., filed Nov. 14, 2017 and issued Aug. 3, 2021, is directed to a technique to securely process and transfer a token in a distributed chain database. The technique includes receiving a valid call to a transfer function to execute a transfer, intercepting the transfer function call and routing a check function to an authorization service that is executed on a chain database, and determining in the authorization service whether the transfer is authorized. The authorization service includes a state that is controlled by a process that is executed off the chain database and returns a value that indicates whether the transfer can proceed. The system then determines whether to validate or invalidate the transfer in response to the returned value.

U.S. Pat. No. 11,356,280 for Personal device security using cryptocurrency wallets by inventors Wright, et al., filed Jul. 10, 2020 and issued Jun. 7, 2022, is directed to a method of encrypting data at an electronic device where the electronic device is associated with a key device. Each device is associated with an asymmetric cryptography pair, each pair including a first private key and a first public key. Respective second private and public keys may be determined based on the first private key, first public key and a deterministic key. A secret may be determined based on the second private and public keys. The data at the electronic device may be encrypted using the determined secret or an encryption key that is based on the secret. Information indicative of the deterministic key may be sent to the key device where the information may be stored.

U.S. Pat. No. 11,349,645 for Determining a common secret for the secure exchange of information and hierarchical, deterministic cryptographic keys by inventors Wright, et al., filed May 11, 2020 and issued May 31, 2022, is directed to a method (300) and system (1) of determining a common secret for two nodes (3, 7). Each node (3, 7) has a respective asymmetric cryptography pair, each pair including a master private key and a master public key. Respective second private and public keys may be determined based on the master private key, master public key and a deterministic key. A common secret may be determined at each of the nodes based on the second private and public keys. In one example, a node (3, 7) may determine the common secret based on (i) a second private key based on the node's own master private key and the deterministic key; and (ii) a second public key based on the other node's master public key and the deterministic key, which may be suited for use with, but not limited to, digital wallets, blockchain (e.g. Bitcoin) technologies and personal device security.

U.S. Pat. No. 11,341,484 for Implementing logic gate functionality using a blockchain by inventors Wright, et al., filed Apr. 28, 2017 and issued May 24, 2022, is directed to a solution in which blockchain Transactions are created to implement the functionality of a logic gate. The solution may be implemented on the Bitcoin platform or an alternative blockchain platform. The transaction includes a locking script which comprises instructions selected so as to implement the functionality of a logic gate such as OR, AND, XOR, NOT and so on. In some examples, the instructions may be provided in a hashed form. When the script is executed (because a second transaction is attempting to spend the output associated with the locking script) the inputs will be processed by the conditional instructions to provide an output of TRUE or FALSE. The second transaction is transmitted to the blockchain network for validation and, if determined to be valid, it will be written to the blockchain. Validation of the second transaction can be interpreted as a TRUE output. Thus, the locking script of the first transaction provides the functionality of the desired logic gate. The solution provides numerous advantages and can be used in a wide variety of applications, such as for the implementation of control systems and processes.

### SUMMARY OF THE INVENTION

The present invention relates to certificate-based security measures for digital assets and blockchain-based account abstractions.

It is an object of this invention to provide an additional safety mechanism for blockchain based transactions to prevent state changes, such as the transfer of one or more tokenized securities, in the event that the digital wallet private key is compromised. It is a further object of this invention to provide a secure means to manage transactions of protected blockchain-based assets (i.e., any form of value operated by smart contracts on a distributed ledger), also referred to as tokenized assets. It is a further object of this invention to provide a locking mechanism to prevent unauthorized transactions from account abstractions on distributed ledgers if a digital wallet private key is compromised.

In one embodiment, the present invention includes a method for locking a tokenized asset in a digital wallet including: a platform including a processor and a memory receiving a locking request to lock the tokenized asset; the platform implementing locking logic and recording a locking record on a distributed ledger; wherein the locking logic is operable to prevent execution of functions affecting the digital asset while the digital asset is locked; wherein the locking record is an entry on the distributed ledger; the platform issuing an unlocking key for unlocking the digital asset; the platform cryptographically hashing the unlocking key to produce a locking hash and recording the locking hash on the locking record; the platform asymmetrically encrypting the unlocking key with a public key associated with the digital wallet holding the digital asset to produce an unlocking code; the platform delivering the unlocking code via a certificate; wherein the unlocking code is decryptable with a private key associated with the digital wallet holding the digital asset to produce the unlocking key; the platform receiving a request to unlock the digital asset; wherein the request to unlock the digital asset includes an unlocking key of the unlocking request; the platform cryptographically hashing the unlocking key of the unlocking request to produce an unlocking hash; the platform comparing the unlocking hash to the locking hash on the locking record; upon matching the unlocking hash to the locking hash, the platform unlocking the tokenized assets; and wherein unlocking the digital asset causes the locking logic to allow execution of functions affecting the digital asset while the digital asset is unlocked.

In another embodiment, the present invention includes a system for applying a locking check on a digital asset including: a platform including a processor and a memory; wherein an unlocking key is generated using an unlocking code by asymmetrically encrypting an unlocking code with a private key associated with a digital wallet holding the digital asset; wherein the platform is operable to receive a request to unlock the digital asset including the unlocking key; wherein the platform is operable to implement locking logic to check a status of a locking record associated with the digital asset to determine the status of the locking record of the digital asset is locked; wherein the status of the locking record associated with the locked digital asset must be unlocked prior to execution of functions affecting the locked digital asset; wherein the platform is operable to cryptographically hash the unlocking key of the unlocking request to produce an unlocking hash; wherein the platform is operable to compare the unlocking hash to a locking hash on the locking record; wherein the platform is operable to determine a match of the unlocking hash to the locking hash, and unlock the digital asset; and wherein unlocking the digital asset causes the locking logic to allow execution of functions affecting the digital asset while the digital asset is unlocked.

In yet another embodiment, the present invention includes a system for applying a locking check on a digital asset including: a platform including a processor and a memory; wherein an unlocking key is generated using an unlocking code by asymmetrically encrypting an unlocking code with a private key associated with a digital wallet holding the digital asset; wherein the platform is operable to receive a request to unlock the digital asset including the unlocking key; wherein the request to unlock the digital asset includes a transfer of a Non-Fungible Token (NFT) of a certificate and the unlocking key to a digital wallet of the platform; wherein the platform is operable to implement locking logic to check a status of a locking record associated with the digital asset to determine the status of the locking record of the digital asset is locked; wherein the platform is operable to mint a NFT corresponding to the locking record; wherein the status of the locking record associated with the locked digital asset must be unlocked prior to execution of functions affecting the locked digital asset; wherein the platform is operable to cryptographically hash the unlocking key of the unlocking request to produce an unlocking hash; wherein the platform is operable to compare the unlocking hash to a locking hash on the locking record; wherein the platform is operable to determine a match of the unlocking hash to the locking hash, and unlock the digital asset; and wherein unlocking the digital asset causes the locking logic to allow execution of functions affecting the digital asset while the digital asset is unlocked.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram of locking and unlocking a digital token by a means of a distributed ledger locking mechanism according to one embodiment of the present invention.

FIG. 2A illustrates a logic flow diagram for implementation of a locking mechanism according to one embodiment of the present invention.

FIG. 2B illustrates a logic flow diagram for implementation of a distributed ledger locking mechanism according to one embodiment of the present invention.

FIG. 3A is a flow diagram of unlocking a digital token by a means of a distributed ledger locking mechanism utilizing an NFT according to one embodiment of the present invention.

FIG. 3B is a flow diagram of unlocking a digital token by a means of a distributed ledger locking mechanism utilizing a paper share certificate according to one embodiment of the present invention.

FIG. 4 illustrates a schematic diagram of a computer architecture of a distributed ledger locking mechanism according to one embodiment of the present invention.

FIG. 5 illustrates a diagram of a paper token certificate according to one embodiment of the present invention.

FIG. 6 illustrates a diagram of an issued paper token certificate according to one embodiment of the present invention.

FIG. 7 is a schematic diagram of a system of the present invention.

### DETAILED DESCRIPTION

The present invention is generally directed to a blockchain locking mechanism to increase the security of assets on distributed ledgers, specifically for increasing the security of tokenized assets.

In one embodiment, the present invention includes a method for locking a digital asset in a digital wallet including: a platform including a processor and a memory receiving a locking request to lock the digital asset; the platform implementing locking logic and recording a locking record on a ledger; wherein the locking logic is operable to prevent execution of functions affecting the digital asset while the digital asset is locked; wherein the locking record is an entry on the ledger; the platform issuing an unlocking key for unlocking the digital asset; the platform cryptographically hashing the unlocking key to produce a locking hash and recording the locking hash on the locking record; the platform asymmetrically encrypting the unlocking key with a public key associated with the digital wallet holding the digital asset to produce an unlocking code; the platform delivering the unlocking code via a certificate; wherein the unlocking code is decryptable with a private key associated with the digital wallet holding the digital asset to produce the unlocking key; the platform receiving an unlocking request to unlock the digital asset; wherein the unlocking request to unlock the digital asset includes an unlocking key; the platform cryptographically hashing the unlocking key of the unlocking request to produce an unlocking hash; the platform comparing the unlocking hash to the locking hash on the locking record; upon matching the unlocking hash to the locking hash, the platform unlocking the digital asset; and wherein unlocking the digital asset causes the locking logic to allow execution of functions affecting the digital asset while the digital asset is unlocked.

In another embodiment, the present invention includes a system for applying a locking check on a digital asset including: a platform including a processor and a memory; wherein an unlocking key is generated using an unlocking code by asymmetrically encrypting an unlocking code with a private key associated with a digital wallet holding the digital asset; wherein the platform is operable to receive an unlocking request to unlock the digital asset including the unlocking key; wherein the platform is operable to implement locking logic to check a status of a locking record associated with the digital asset to determine the status of the locking record of the digital asset is locked; wherein the status of the locking record associated with the locked digital asset must be unlocked prior to execution of functions affecting the locked digital asset; wherein the platform is operable to cryptographically hash the unlocking key of the unlocking request to produce an unlocking hash; wherein the platform is operable to compare the unlocking hash to a locking hash on the locking record; wherein the platform is operable to determine a match of the unlocking hash to the locking hash, and unlock the digital asset; and wherein unlocking the digital asset causes the locking logic to allow execution of functions affecting the digital asset while the digital asset is unlocked.

In yet another embodiment, the present invention includes a system for applying a locking check on a digital asset including: a platform including a processor and a memory; wherein an unlocking key is generated using an unlocking code by asymmetrically encrypting an unlocking code with a private key associated with a digital wallet holding the digital asset; wherein the platform is operable to receive a request to unlock the digital asset including the unlocking key; wherein the request to unlock the digital asset includes a transfer of a Non-Fungible Token (NFT) of a certificate and the unlocking key to a digital wallet of the platform; wherein the platform is operable to implement locking logic to check a status of a locking record associated with the digital asset to determine the status of the locking record of the digital asset is locked; wherein the platform is operable to mint a NFT corresponding to the locking record; wherein the status of the locking record associated with the locked digital asset must be unlocked prior to execution of functions affecting the locked digital asset; wherein the platform is operable to cryptographically hash the unlocking key of the unlocking request to produce an unlocking hash; wherein the platform is operable to compare the unlocking hash to a locking hash on the locking record; wherein the platform is operable to determine a match of the unlocking hash to the locking hash, and unlock the digital asset; and wherein unlocking the digital asset causes the locking logic to allow execution of functions affecting the digital asset while the digital asset is unlocked.

None of the prior art disclosed a flexible locking mechanism to manage the execution of smart contract functions that is applicable to tokenized assets, account abstractions, or other smart contract applications to maintain protection of digital assets separate from protections of the operator's digital wallet as described in the present application.

A stock certificate (commonly referred to as a “certificate of stock,” “share certificate,” or “paper share certificate”) is a legal document that certifies a legal interest in ownership of a number of shares or stock in a corporation. Traditionally, paper share certificates were used to show proof of ownership and as a marker of pride for an interest in a corporation. In many markets, paper share certificates have been replaced by electronic proof of ownership, a process called dematerialization, there are a number of benefits to utilizing certificated shares. Paper share certificates serve as a tangible proof of ownership, display of pride or decoration, a memory aid, a repository of useful information pertaining to ownership interest, a number of regulatory benefits, and in some cases can even prevent unauthorized movement of value. Most important, as a bearer instrument (i.e., one whose holder is entitled to the rights of ownership) paper certificates are immune to cyber attack, tampering by the record keeper, or loss of custody of the controlling account by accident or loss of continuity of an intermediary. Additionally, in many jurisdictions, due to the security benefits of an additional method to certify ownership not dependent on a centralized record keeper, certificated shares are afforded regulatory benefits including fewer restrictions on the operations of the record keeper. As a result, certificated shares remain an important part of regulated economies.

However, there are a number of disadvantages to paper share certificates. Paper certificates can be damaged, which occurred in 2012 when Hurricane Sandy flooded the Depository Trust & Clearing Corporation (DTC) damaging over $1 billion in paper share certificates. Additionally, paper share certificates are labor intensive and expensive to produce.

Paper share certificates becoming less commonplace and are being replaced with digital records to indicate proof of ownership. While this has profound benefits to market efficiency, it subjects owners to large scale risk of cyber attack, record-keeping errors, or fragmentation of ownership data. All are common, especially in private markets and result in substantial costs to support and reconcile transactions. In an effort to revolutionize and optimize the exchange of stock and other securities many have turned to the use of blockchain to provide an immutable, transparent record of ownership. The field is rapidly moving towards the tokenization of securities and the transfer of such tokens on Distributed Ledger Technology (DLT) such as the Ethereum Blockchain. Tokenizing securities is the process of memorializing the ownership in a security through the issuance of a fungible token (hereafter, “digital token”) registered on DLT such as, blockchain or the Ethereum ledger.

As a result, shares and other securities can be represented, held, and transferred as a digital token on a DLT, which has a number of benefits. DLT provides transparency without the need for a central authority, document provenance, a digital format that is carbon-neutral, transfers that are easily managed, and low-cost transactions. However, there are some notable downsides to this new era of securities transfer, including the difficulty in maintaining regulatory compliance, the requirement that the investor or stock holder be tech savvy, vulnerability to cyber threats, and the consequence of having a single private key to control transactions.

More specifically, for tokenized securities transactions, investors must maintain a digital wallet. A digital wallet is a financial transaction application that enables uses to transact and “hold” assets on a DLT. A digital wallet is associated with two types of keys, a public key and a private key. The public key may be shared with others and is used to receive funds. However, the private key must be kept in absolute secrecy because it is used to transfer funds. Compromise of one's private key by a bad actor likely means the compromise of the entire contents of the digital wallet. This is the central point of concern for modern securities holders, having only a single line of code as the sole security measure for all valuable interest in a corporation. More specifically, one's digital wallet can be thought of as an extension of their identity used to authorize a plurality of transactions on DLT. Due to the frequency of private key use to authorize DLT transactions, all assets operated by the digital wallet are subject to compromise if any transaction results in compromise of the private key. Investors are rightfully apprehensive about stepping into the new age of tokenized securities transactions, especially for experienced investors who are more comfortable with physical paper share certificates or who are rightly concerned about the sophistication of cyber threat actors. There is a considerable amount of friction between the traditional model of transferring, holding, and issuing securities and the modern model of doing the same. The current age marks a particularly unique crossroads between paper share certificates and tokenized assets. Additionally, this crossroads requires a need to increase the cyber security of DLT transactions, due to the importance of an all controlling, single private key.

There is a need to implement a method that provides the transaction and record keeping efficiency of DLTs, while providing a secure antidote to cyber security risks offered by bearer instruments. Additionally, there is a need to increase the security of digital assets by implementing a transaction lock to implement a physical security measure so that compromise of a digital wallet's key does not spell disaster for the investor. Further, there is a need to bridge the advanced technology benefits of blockchain to less savvy market participants who prefer a tangible physical record of ownership. To solve these needs, the present invention is directed to a DLT locking mechanism or “transaction lock” that activates upon issuance of a physical or electronic certificate, such that investors have a familiar ownership instrument while gaining the benefits of DLT with added security measures.

In one embodiment, the present invention is directed to a method of ensuring digital wallet security by implementing a locking mechanism, by a platform including a processor and a memory, upon issuance of a certificate, such that the digital wallet is restricted from: conducting unauthorized transactions on a DLT, performing unauthorized controlled functions on protected digital assets (e.g., tokenized securities), operating protected account abstractions, and/or executing unauthorized state changes on a computer network.

In one embodiment, the locking mechanism is operable to lock the entire digital wallet from making transfers. In one embodiment, the locking mechanism is operable to lock specific functions, such as transfer functions or any similar ownership altering function) for a specific digital asset (often referred to as a protected asset) within a digital wallet, while maintaining the means of conducting other transactions via the digital wallet. In one embodiment, the locking mechanism is operable to prevent any or all state changes via an account abstraction as initiated by a digital wallet. In one embodiment, the locking mechanism is operable to lock a set of digital tokens based on a common or uncommon characteristic, while maintaining fluidity of the digital wallet. In one embodiment, the locking mechanism is implemented and/or activated by a trusted entity responsible for recordkeeping of bondholders and shareholders (registrar) of the issuing asset. In one embodiment, the locking mechanism is triggered upon request or issuance of a certificate. In one embodiment, the certificate is recorded on a physical paper or is an electronic record. In one embodiment, the paper share certificate includes a wallet secret, unlocking code, and/or unlocking key necessary to unlock or remove the locking mechanism preventing specific functions. In one embodiment, the unlocking key is asymmetrically encrypted to produce an unlocking code that is transmitted securely to the asset owner (often referred to as the investor) who has the means to decrypt the unlocking code to produce the unlocking key required to unlock the locking mechanism and operate the asset. In one embodiment, unlocking key or unlocking code is transmitted using a Quick Response (QR) code to facilitate convenient scanning and use by the investor. In one embodiment, a hash of the unlocking key is assigned to a non-fungible token (NFT) representing the certificate, the smart contract issuing the NFT contains logic required to validate and unlock the protected asset and/or digital wallet, and the NFT is transferred to the digital wallet of the investor. In one embodiment, the locking mechanism is removed upon the registrar's validation of the investors's possession of the unlocking key. In one embodiment, the operator validates possession of the unlocking key by signing a transaction using the unlocking key. In one embodiment, possession of the unlocking key is validated by producing a matching hash generated from the unlocking key. The locking mechanism is implemented through a plurality of processes.

In one embodiment, the present invention includes a platform operable to receive requests to purchase protected assets (e.g., tokenized securities) and transfer those protected assets to a digital wallet of the purchaser (investor). The platform preferably includes at least a processor and a memory. In one embodiment, the platform includes a server computer or one or more edge devices for sending and receiving data. The platform is operable to receive requests to lock the protected assets and unlock (or remove the lock) the protected assets for transfer. Upon request the platform is operable to create and/or implement the locking mechanism or transfer lock described herein. In one embodiment, the platform is operable to record a locking record that is operable to facilitate the functions of the locking mechanism while displaying information about the underlying asset and the locked or unlocked status of the protected asset. The platform is further operable to facilitate the unlocking request to determine whether the transfer lock should be lifted or maintained. In this embodiment, the platform is operable to compare the presented unlocking key of the unlocking request to the unlocking key that was created upon instantiation of the transfer lock. In one embodiment, a hash of the presented unlocking key is compared to a hash of the initially created unlocking key. The platform is then operable to determine if there is a match, indicating that the unlocking request is from the legitimate investor of the protected assets. Upon determination of the legitimacy of the unlocking request, by concluding an exact match of unlocking keys, the platform is operable to remove the transaction lock and/or unlock the transaction lock. In one embodiment, the platform removes the transaction lock and/or unlocks the transfer lock by executing a transaction to set data on the DLT that affects the ability to perform a plurality of functions via the protected asset or account. The platform is operable to remove the transaction lock and/or unlock the transfer lock by recording a transfer unlock entry on the DLT. The platform is operable to serve as a medium between investor, registrar, protected asset, and corporation to facilitate the functions of the transfer lock, as well as, receive requests to lock and unlock the protected assets, process those requests, and remove and/or unlock the transfer lock upon confirmation of the legitimacy of the requests. In one embodiment, the platform includes a processor and a memory. In one embodiment, the platform is operable to interact with a DLT using at least one smart contract. In one embodiment, the platform is operable to transact on the DLT. In one embodiment, the platform is operable to affect ownership functions of digital tokens on the DLT. In one embodiment, the platform is operable to mint an asset as a NFT. In one embodiment, the platform is operable to mint an asset as a Fungible Token (FT). In one embodiment, the platform is operable to affect functions of an account abstraction. In one embodiment, the platform is operable to record ownership entries and other data onto a DLT. In one embodiment, the digital wallet associated with the investor is a multi-asset solution digital wallet that is operable to hold a plurality of digital tokens. In one embodiment, the digital wallet associated with the registrar is a multi-asset solution digital wallet that is operable to hold a plurality of digital tokens.

In one embodiment, the locking mechanism is implemented where securities, preferably shares of ownership in a corporation (stock or share), are issued and represented by a digital token and assigned to a specific entity who owns the stock (investor). In one embodiment, a registrar records the investor's ownership interest on a DLT and assigns a digital wallet to the investor. In one embodiment, the DLT is the Ethereum distributed ledger, another public distributed ledger, a private distributed ledger, and/or a hybrid ledger (i.e., where data is recorded both on and off chain).

Following issuance, a request is made, preferably by the stock owner or “investor,” to the registrar for a certificate. In one embodiment, the investor makes the request through the locking platform, implemented via an Application Programming Interface (API), web-based interface, or other similar electronic communication means known in the art. In one embodiment, the investor need only indicate to the registrar that they desire additional security measures for the registrar to place a lock on the asset and issue the investor a certificate, the certificate containing the means to unlock and operate the asset. In one embodiment, the registrar issues the investor a certificate automatically without the investor making the request.

Upon request (or similar process described above) for a certificate a transaction locking mechanism (hereafter “transaction lock”) is activated and/or implemented. In one embodiment, the transaction locking mechanism is enforced through locking logic, implemented by a locking record on the DLT. In one embodiment, the smart contract functions operable to affect the ownership of the protected assets includes additional locking logic, operable to automatically implement the transaction lock upon creation. In one embodiment, he certificate contains information needed to unlock the protected asset or account. In one embodiment, the certificate includes the private key associated with the digital wallet. In one embodiment, the certificate contains an unlocking key which is presented by the affected wallet investor in order to unlock the asset. In one embodiment, the certificate includes an unlocking code, an encrypted version of the unlocking key that must be decrypted by the wallet operator to present the unlocking key for verification to unlock the protected asset or account. In one embodiment, the certificate may be delivered as a paper share certificate. In one embodiment, the certificate may be delivered electronically. In one embodiment, the certificate may be delivered as a NFT to the digital wallet.

The transaction lock is implemented to provide an additional layer of security for investors who are unfamiliar with operating digital wallets or are concerned about the compromise of their digital wallet through loss of the private key. In one embodiment, the transaction lock is operable to prevent asset value transfer despite the private key of a digital wallet being compromised. In one embodiment, the transaction lock is operable to prevent a transfer of a locked protected assets even though the transfer request utilizes the private key of the digital wallet holding the protected assets and would, absent the transaction lock, affect the transfer. In one embodiment, the transaction lock is one of many checks performed to assess the legitimacy of a proposed transaction. In one embodiment, the transaction lock is an additive security measure to other digital token security measures known in the art. In one embodiment, the transaction lock is operable to prevent certain digital tokens from being transferred while allowing other digital tokens associated with the digital wallet to be freely transferable. In one embodiment, the transfer lock is operable to prevent digital token transfer while allowing the contents of the digital wallet to be viewed by others (e.g., display the current number of shares, the shareholder, the value of the shares, etc.). In one embodiment, the transfer lock is operable to put others on notice of the locked (or unlocked) status of a digital wallet. In one embodiment, the transfer lock is facilitated by a locking record on the associated DLT.

In one embodiment, the present invention implements a locking mechanism for account abstraction, that is a smart contract that processes requested state changes originated by externally operated accounts (digital wallet operated using public/private key pairs) by authorizing the request and routing to the appropriate smart contract for execution. Thus, an account abstraction acts as a unique address (also known as smart contract wallet) through which value can be held and operated. Account abstraction reduces the friction of self-custodial wallet products (i.e., simply holding the private key to a digital wallet) and allows everyday users to store their digital assets and customize their security preferences. This is accomplished by requiring the transaction to be first signed on the client side by the digital wallet then being sent to an account smart contract on the DLT before routing for execution by the target smart contract. Each account smart contract can be deployed and tailored with custom authorization logic. The account smart contract is free to implement whatever functional logic the owner desires. This opens the door for creative wallet design and allows developers to integrate efficient, secure, and easy security measures. By inserting the disclosed locking mechanism into the account abstraction smart contract, the disclosed invention introduces a physical security mechanism to protect digital assets and mitigate cyber security risks resulting from a compromised private key of the operator's digital wallet. In one embodiment, the locking mechanism is applied to a digital token. In one embodiment, the locking mechanism is applied to any or all operations facilitated by account abstraction. One of ordinary skill in the art will appreciate that the discussion that follows, while focusing of locking a tokenized asset, is also applicable to locking an account created by account abstraction.

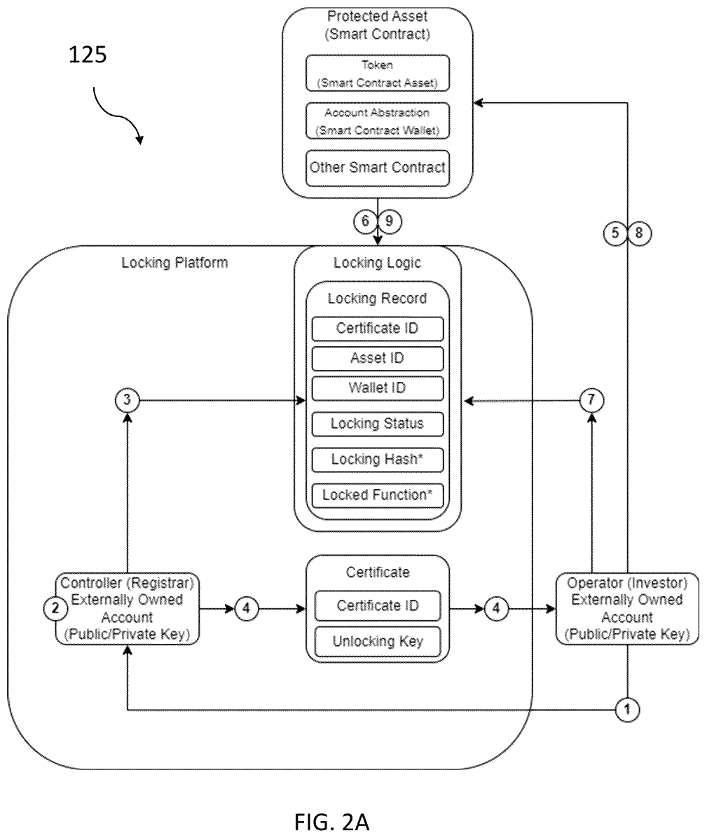

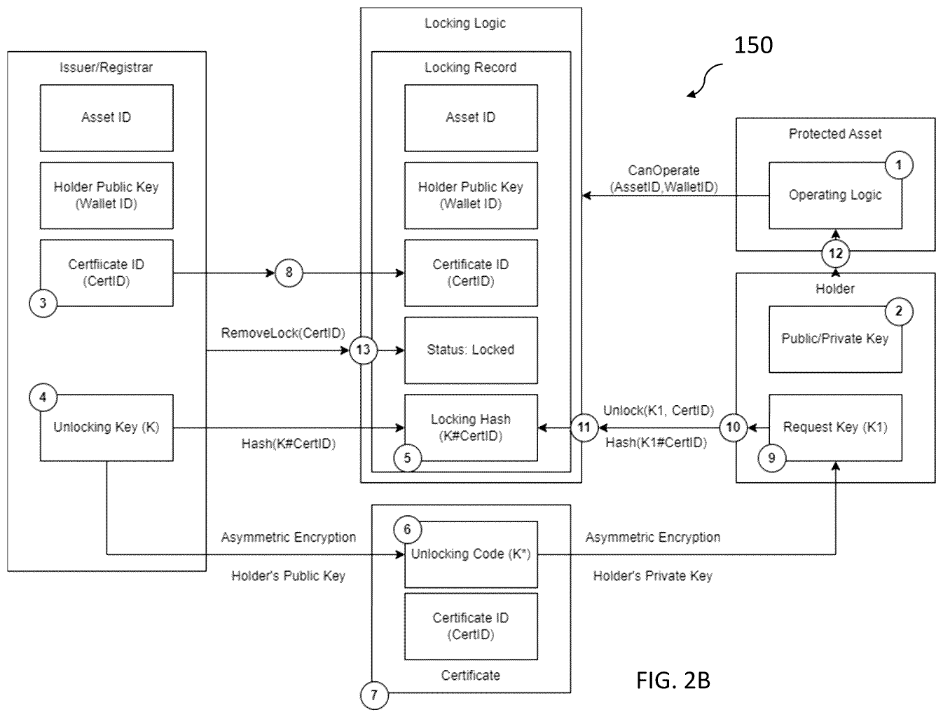

In one embodiment, the locking mechanism is facilitated through locking logic. The locking logic maintains a registry of locks stored as Locking Records, each locking record a specific lock applied to an asset/wallet pair. In one embodiment, the locking record is a recorded transaction and/or data posted on a DLT that includes a plurality of information pertaining to the tokenized asset and includes a plurality of locking mechanism functions through smart contract logic. In one embodiment, the locking record includes the asset ID, the wallet ID (public key), the certificate ID, the current lock status of the tokenized asset, and the locking hash (as illustrated in FIGS. 2A and 2B). In one embodiment, the locking mechanism includes a smart contract operable to issue the locking record as an NFT. In this embodiment, the locking record NFT includes the plurality of data fields above and illustrated in FIGS. 2A and 2B. In one embodiment, the smart contract logic of the protected asset references the locking record to determine if a locking record exists, if the locking status of the protected asset is set to lock, and/or if the locking status of the protected asset is set to unlock. In one embodiment, the locking records includes the locking hash, which is a cryptographic hash of the unlocking key. In one embodiment, the platform is operable to utilized the locking hash of the locking record to determine if an unlocking request includes an exact match indicating that the true owner of the tokenized assets desired to unlock the transfer lock.

In one embodiment, the transaction lock is operable to prevent the operation of a plurality of function of a protected account abstraction via an investor's digital wallet. In one embodiment, the transaction lock is operable to prevent a specific investor's digital wallet from transferring a specific digital token from being transferred to another digital wallet. In one embodiment, the transaction lock is operable to prevent a plurality of digital tokens from being transferred.

In one embodiment, the transaction lock is enforced by a locking script. The locking script implements a transaction lock by executing logic to determine if a condition and/or an additional condition is met in order for a state change (e.g., an ownership transfer) to occur. In one embodiment the condition and/or additional condition restricts transfer of the digital token until the condition and/or the additional condition is met. In one embodiment, the condition includes the protected asset or account being in an unlocked state. In one embodiment, the locking script depends on input of a correct match of a hash of the requesting unlocking key to a hash of the originally created unlocking key. In one embodiment, the locking script may be used in conjunction with other transaction validating logic to authorize further transaction processing.

In one embodiment, the locking script includes the issuance of a locking record for every protected asset and/or wallet pair. In one embodiment, the locking record contains at least one data field that contains the locking state and/or status of the protected asset. In one embodiment, a plurality of locked and/or unlocked states are maintained by the locking record. The unlocking and/or locking state is adjusted by the unlocking mechanism and proper verification of the unlocking key. In one embodiment, the locking record also contains the protected asset identifier and/or account identifier, the public key of the wallet whose activity is affected by the lock, an identifier for the certificate, and a verification used to certify the presence of the unlocking key during unlocking operations.

In one embodiment, the locking script is executed by a smart contract, compound smart contract, and/or an additional smart contract referred to as Locking Logic. The Locking Logic performs the following functions: issues the Locking Record; enables the validation of the locked Status of a Protected Asset by implementing the CanOperate function; and/or sets the Status to unlocked based on a successful Unlock request by a valid request unlocking key match. In one embodiment, the locking logic supports following functions IssueLock(assetID, walletID, certificateID, validationHash); CanOperate(assetID, walletID) returning true/false for locked status, and/or Unlock(key, certificateID). In one embodiment, functionID is added to the functions above to allow locking of specific functions for a protected asset or account. In one embodiment, the Locking Record is issued as a NFT containing the data fields described above and delivered to the affected wallet for reference.

In one embodiment, the locking mechanism is enforced by altering the transfer functions of the smart contracts associated with the digital token. In one embodiment, the locking mechanism is enforced by including a lock check into the smart contract functions of the Ethereum Request for Comment standard 20 (ERC-20), ERC-721, ERC-1155, and/or similar token standard. In one embodiment, the protected asset is a digital token implementing the ERC-20) ERC-721, ERC-1155, and/or similar token standard. In one embodiment, the transfer functions are the transfer, transferFrom, and approve, functions of the ERC-20 transfer smart contracts. In one embodiment, the transfer functions are those that accompany the ERC-721, ERC-1155, and/or similar token standard. In one embodiment, the transfer functions are modified to require a check for a transaction lock prior to executing a transaction. In one embodiment, where the transfer functions identify the presence of a transfer lock, the transfer is rejected and prevented from occurring. In one embodiment, where the transfer functions identify the absence of a transfer lock, the transfer is approved and allowed to occur.

A code sample illustrating the use of the canOperate function call to the locking logic smart contract from an ERC-20 token smart contract representing a protected asset is provided below. The request to the locking logic includes the assetID and the walletID for the requestor:

```
function transfer(address _to, uint256 _amount) public returns (bool) {
    require(assetLocking.canOperate[assetID, msg.sender],
    ‘Asset is locked’);
    if (_amount <= balanceOf(msg.sender) {
      _transfer(msg.sender, _to, _amount);
      return true;
    }
    revert(‘Insufficient Balance’);
  }
```

In general, the “assetLocking.canOperate( . . . ” logic can be inserted into any smart contract, not just a token smart contract to implement the disclosed locking mechanism. For example, the canOperate function can be injected into an account abstraction smart contract to implement the disclosed mechanism on any or all account abstraction functions. An embodiment that includes a functionId on the can operate functions provides a means to protect specific smart contract function via the locking mechanism.

In one embodiment, the transaction lock includes the mechanism of a locking script, a modified token transfer function, and/or an additional smart contract to enforce the locking status of a digital wallet, digital token, and/or plurality of digital tokens.

In one embodiment, the transaction lock is operable to trigger a smart contract to post the locking status of the wallet/token onto a DLT. In one embodiment, the transaction lock includes smart contract functions that post the locking status of the protected asset or account onto the DLT by updating the locking record.

In one embodiment, the transaction lock is enforced by inserting code into the digital token's transfer functions of the digital token's smart contract that is operable to check for a transfer lock prior to executing the transfer functions associated with the digital token. In one embodiment, the transaction lock is data stored on a DLT and indexed by the affected digital wallet and protected asset or account indicating a transaction restriction. In one embodiment, the transaction lock is a smart contract function that is operable to restrict the digital wallet from making transfers.

In one embodiment, the transaction lock is based on the use of a wallet private key as the unlocking key. In this embodiment, the protected asset is placed in the affected wallet and the unlocking key is delivered to the investor via the certificate. The investor obtains the unlocking key from the certificate, imports the private key into a wallet to operate the protected asset, and proceeds as desired to operate the protected asset via the wallet.

In one embodiment, the transaction lock is operable to restrict transaction of a protected asset and/or account, and/or plurality of digital tokens and by preventing transactions via the protected asset or account until the investor executes an unlocking transaction using an unlocking key in the form of a wallet private key delivered via a certificate. In any embodiment where the unlocking key is a wallet secret, the platform and/or registrar creates the asset, creates the digital wallet or abstract account to operate the asset or account, delivers the asset or account to the digital wallet, and transfers the unlocking key to the investor via a secure method. The private and public key in this embodiment are generated using techniques understood by those of ordinary skill in the art depending on the method required for the specific DLT in which the protected asset or account resides.

In the preferred embodiment, the platform and/or registrar need only know the public key of the investor's digital wallet. In this embodiment, the platform and/or registrar delivers the protected asset or account to the public key of the investor's digital wallet using methods understood by those of ordinary skill in the art, creates the unlocking code by encrypting the unlocking key (a random string of sufficient length to provide desired security) using asymmetric encryption with the public key, delivers the unlocking code via a certificate, and issues the locking record via the locking logic as described above.

In one embodiment, upon implementation of the transaction lock and delivery of the unlocking key, a hash of the unlocking key is stored as a locking record. In one embodiment the hash algorithm is a Secure Hash Algorithm-512 (SHA-512) and/or other hashing algorithm known in the art. In one embodiment, the unlocking key hash is stored in an internal database. In one embodiment, the locking record is assigned to a Non-Fungible Token (NFT). In one embodiment, the locking record corresponds to a paper token certificate carrying the Certificate ID.

In one embodiment the paper share certificate does not include the unlocking code, wallet secret, and/or hash of the unlocking code or wallet secret. In one embodiment, the locking record NFT is assigned and/or transferred to a digital wallet associated with the investor. In one embodiment, the unlocking key is held by the platform and/or registrar in a locking record stored privately by the registrar and transmitted via the certificate to the investor. In one embodiment, the platform and/or registrar does not need to store the unlocking key in any form as it is encrypted irreversibly via the hash function and encrypted (irreversibly by the platform and/or registrar) using asymmetric encryption and sent to the investor via the unlocking Code in the certificate. Proper verification of the unlocking key is performed by the investor decrypting the unlocking Code using the private key of the wallet and hashing the resulting unlocking Key to check for a match against the original hash of the unlocking key created by the platform and/or registrar. This is the preferred embodiment, as a compromise of the platform and/or registrar does not expose the unlocking Key.

In one embodiment, upon implementation of the transaction lock the issuance of the unlocking key is accomplished through a certificate that represents the protected asset or account (e.g., the securities). In one embodiment, the certificate may be transmitted and stored on paper or other medium (hereafter “paper token certificate”). In one embodiment, the paper token certificate includes two separable portions, such as a main portion and a tear-off portion. The main portion is operable to include a plurality of information relevant to the underlying tokenized asset, the digital token, and the relevant corporation. In one embodiment, the tear off portion includes a Quick Response (QR) code of the unlocking key and/or unlocking code. In one embodiment, the tear-off portion includes a plurality of information related to the unlocking code.

In one embodiment, the unlocking key is coded into a QR code. The QR code of the tear-off portion, upon scanning, provides the investor with the unlocking key and/or unlocking code needed to unlock and/or lift the transaction lock. In order to unlock and/or lift the transaction lock the unlocking key is sent to the registrar in a plurality of ways that will be discussed in detail below. In one embodiment, the platform and/or registrar exclusively retains a hash of the unlocking key. In one embodiment, upon receipt of a request to unlock and/or lift the transaction lock through the sending of a wallet secret, the platform and/or registrar makes a hash of the sent unlocking key and compares it to internal records of a hash of the unlocking key In one embodiment, the unlocking key is presented by the investor using an Unlock function implemented via a smart contract. In this embodiment, a hash produced from the unlocking key is compared to the locking record hash via locking logic smart contract, to automatically set the locking status in the locking record. In one embodiment, the unlocking code representing an encrypted form of the unlocking key and is embedded in the QR code of the paper token certificate for use by the investor.

In one embodiment, the transaction lock is removed by a smart contract upon production of the unlocking key. In one embodiment, the transaction lock is removed by a smart contract upon furnishment of the unlocking key to the platform and/or registrar. In one embodiment, the transaction lock is removed upon signing of an unlocking function using the wallet's private key provided as the unlocking key to the investor.

In one embodiment, the locking mechanism involves a process where a protected asset, such as a stock or other securities, is issued as a digital token and assigned to a digital wallet associated with an investor. In one embodiment, the ownership interest in the digital token is recorded onto a DLT. Upon request for a paper token certificate, the platform and/or registrar associated with the issuing body of the stock or other securities implements a transaction lock. Upon issuance of a paper token certificate, a transaction lock is created and/or implemented to restrict transactions associated with the digital token associated with the paper token certificate. In one embodiment, the transaction lock is operable to prevent transfer of the digital token representing the asset, a plurality of digital tokens, and/or any transfers from the digital wallet associated with the investor. In one embodiment, upon implementation and/or creation of the transaction lock, an NFT of a paper token certificate is minted onto a DLT. In one embodiment, the NFT does not include the wallet secret and/or unlocking code. In one embodiment, the NFT does not include the unlocking code. In this embodiment, the unlocking key associated with the transaction lock is hashed and assigned to the NFT of the paper token certificate. In this embodiment, the NFT of the paper token certificate is transferred to the digital wallet of the investor. In one embodiment, upon transfer of the NFT, a physical paper token certificate is sent to the investor associated with the digital wallet.

In one embodiment, the paper token certificate includes a main portion and a tear-off portion. In this embodiment, the main portion includes information related to the underlying asset associated with the digital token. In this embodiment, the tear-off portion contains a QR code of the unlocking key and/or unlocking code. In one embodiment, in order to request that the transaction lock be unlock and/or lift the transaction lock, the NFT associated with the paper token certificate is transferred to a digital wallet associated with the platform and/or registrar of the protected asset. In one embodiment, the transfer of the NFT to the digital wallet of the registrar provides proof of possession of the unlocking key in the execution of the transaction.

In one embodiment, a hash of the unlocking key in the metadata of the transaction is compared to a hash of the unlocking key stored in the platform's and/or registrar's internal records. In one embodiment, where the hash of the received unlocking key matches the hash of the internal database, the transaction lock is unlocked and/or lifted. In one embodiment, where the hash of the received wallet secret does not match the hash of the internal database, the transaction lock is maintained. In one embodiment, where the hash of the received wallet secret matches the hash of the internal database, the NFT is “burned” or transferred to the platform's and/or registrar's wallet, the transfer affecting the unlocking of the protected asset or account.

In one embodiment, the locking mechanism involves a process where an asset, such as a stock or other securities, is issued as a digital token and assigned to a digital wallet associated with an investor of the stock or other securities. In one embodiment, the ownership interest in the digital token is recorded onto a DLT. In one embodiment, upon request for a paper token certificate, the registrar associated with the issuing body of the stock or other securities implements and/or creates a transaction lock. In one embodiment, upon issuance of a paper token certificate, the transaction lock is implemented and/or created. In one embodiment, upon issuance of a paper token certificate, the platform and/or registrar removes all personal data records of the unlocking key and/or the unlocking code. In one embodiment, once the unlocking code is produced, the platform and/or registrar does not retain a copy of the unlocking key. In one embodiment, the transaction lock is operable to prevent transfer of the digital token, a plurality of digital tokens, and/or any transfers from the digital wallet associated with the investor.

In one embodiment, the paper token certificate includes a QR code of the unlocking key and/or unlocking code associated with the transaction lock. In one embodiment, a hash of the unlocking code and/or unlocking key is maintained in a conventional database, server computer, or similar storing mechanism known in the art. In one embodiment, following implementation and/or creation of the transfer lock, the paper token certificate is sent to the investor associated with the digital wallet. Following issuance of the paper token certificate and implementation of the transfer lock, any request to transfer the digital token from the digital wallet of the investor is rejected.

In one embodiment, in order to unlock and/or lift the transaction lock, a request is made through an Application Programming Interface (API) or similar web-based interface to unlock and/or lift the transaction lock. In one embodiment, the request includes the unlocking key and/or unlocking code associated with the transaction lock and QR code. In one embodiment, a hash of the unlocking key from the request is compared to a hash of the unlocking key associated with the investor of the digital wallet maintained in a database. In one embodiment, the unlocking key is asymmetrically encrypted with the public key of the investor's digital wallet to produce the unlocking code. In one embodiment, the unlocking code is decrypted using the private key of the investor's digital wallet to produce the unlocking key. Where the hash of the unlocking key from the request matches that of the hash of the database, the transaction lock is unlocked and/or lifted. Where the hash of the unlocking key from the request does not match the hash of the database, the transaction lock is maintained. In one embodiment, the transaction lock is operable to restrict the digital wallet from transferring the digital token despite the digital wallet's private key being compromised and/or disclosed to a third party. In one embodiment, the transaction lock is implemented as a locking record on a DLT. The locking record is minted as an NFT and includes relevant information. Advantageously, the NFT embodiment adds additional benefit of decentralization including the resilience of decentralized systems. The use of an on-chain locking record provides additional transparence and assurance that locking operations are available and work as desired.

While the present disclosure relates the transaction lock to the issuance of a paper token certificate, one of ordinary skill in the art will appreciate that the transaction locking mechanism is applicable to other situations where a restriction on transactions is desired. One of ordinary skill in the art will appreciate that the issuance of a paper certificate that includes an unlocking key and/or unlocking code associated with a transaction locking mechanism is only a specific use case of the locking mechanism.

For example, the unlocking key may consist of a wallet secret or other randomly generated secure string. By using a secure string as the unlocking key rather than a wallet private key, the locking operation does not affect operations that are not on the protected asset or account. The unlocking key may be encrypted using asymmetric encryption to create an unlocking code which provides enhanced security in transmission and storage by the platform to the investor. The unlocking key/code may be electronically transmitted to the investor using a certificate, in the form of a digital file, an NFT, and/or as a paper share certificate or other medium. The paper certificate or locking record material contains information for the benefit and convenience of the investor. In one embodiment, the paper certificate does not contain locking information. The locking record may be stored on or off chain. The unlocking mechanism may be implemented on chain using smart contracts, off-chain using traditional data storage methods, or manually by the registrar. The transaction lock may apply to protected assets such as a digital token, protected account such as account abstractions and smart contract wallets, or to any smart contract or smart contract function. The locking mechanism may be implemented alone or in conjunction with other transaction approval methods.

Referring now to the drawings in general, the illustrations are for the purpose of describing one or more preferred embodiments of the invention and are not intended to limit the invention thereto.

The blockchain locking mechanism is operable to function on a plurality of distributed ledgers (DLT) including public distributed ledgers such as Bitcoin Blockchain and Ethereum Blockchain, private distributed ledgers, and/or hybrid distributed ledgers. In one embodiment, the transfer lock is operable to prevent transfers of digital tokens from one digital wallet on a DLT to another digital wallet on a DLT.

In one embodiment, the digital token is created according to the Ethereum Request for Comment 20 (ERC-20), ERC 721, and/or other similar fungible token standard. In this embodiment, the fungible token standard that the digital token is subject to includes an additional transfer smart contract and/or modification to an existing smart contract that includes a locking mechanism (transfer lock and locking mechanism are used interchangeably).

In one embodiment, the distributed ledger locking mechanism includes a locking script operable to prevent digital token transfers without the wallet secret.

In one embodiment, the locking status of a digital wallet and/or a digital token is posted and/or written onto a DLT, such as the Ethereum Blockchain, by transferring a zero or nonzero amount of digital currency from one digital wallet to another digital wallet with a hash of the status message included in the transfer. In one embodiment, the locking record is stored as data managed by the locking logic smart contract. The locking status is stored as a Boolean, integer, or string record (eg true/false) indexed by the certificateID and/or the locked asset/wallet combination. In one embodiment, the locking status of a protected asset or account is observed as the status corresponding to a certificate ID and/or asset/wallet pair.

In one embodiment, the transfer lock is operable to lock a digital wallet from transferring a specific digital token or a plurality of specific digital tokens from transfer, while allowing the remainder of the assets in the digital wallet to be free to transfer. In one embodiment, the transfer lock is operable to prevent all transactions for protected assets or accounts by a digital wallet. In one embodiment, the transfer lock is operable to lock a specific digital token or a plurality of specific digital tokens from transfer, even if the private key to the digital wallet is compromised. In one embodiment, the transfer lock is operable to lock a digital wallet from transferring a specific or plurality of specific digital tokens from transfer. In one embodiment, the transfer lock is operable to require an additional signature and/or unlocking key in order to sign transactions of a specific or plurality of specific digital tokens from one digital wallet to another. In one embodiment, the additional signature and/or secret is the wallet secret assigned to the QR code of the paper token certificate. In one embodiment, the transaction lock is operable, upon transfer request, to check the specific or plurality of specific digital tokens for a transfer lock.

In one embodiment, the locking mechanism is operable to implement a transfer lock into the transfer functions of the smart contracts controlling the transfer of a specific or a plurality of specific digital tokens. In one embodiment, upon request to transfer the specific or plurality of specific digital tokens, the locking mechanism is operable to initially check for a transfer lock. In one embodiment, the locking mechanism is operable to be implemented onto the ERC-20 standard, such that the transfer, transferFrom, and approve functions include a check for a transfer lock. In one embodiment, the wallet secret is operable to lift the transfer lock.

As a nonlimiting example, the transfer lock is implemented into the ERC-20 standard by the following code:

```
function transfer(address _to, uint256 _amount) public returns (bool) {
    require(assetLocking.canOperate[this, msg.sender],
    ‘Asset is locked’);
    if (_amount <= balanceOf(msg.sender) {
      _transfer(msg.sender, _to, _amount);
      return true;
    }
    revert(‘Insufficient Balance’);
  }
```

In this example, the “require(assetLocking.canOperate[this, msg.sender], ‘Asset is locked’)” indicates that the digital token is subject to a transfer lock of the present invention and any attempt to transfer the digital token will be prevented until the transfer lock is unlocked. This example further exemplifies how the transfer lock is implemented on top of and before the transfer functions of known digital token standards. As illustrated by the example code above, the transfer lock function or “lock check” is required to occur prior to the remaining transfer functions. Effectively adding to the security functions of the digital token standard. Why the example code above is applied to the ERC-20 token standard, one of ordinary skill in the art will appreciate that the same method is applicable to a plurality of token standards known in the art.

In one embodiment, the transaction lock is removed and/or invalidated by signing a transaction to remove and/or invalidate the locking record for transfers of the tokens referenced in the paper token certificate. In one embodiment, the transaction to remove and/or invalidate the transaction lock is signed by a private key of the registrar's digital wallet. In one embodiment, upon correct comparison of unlocking key hash the platform and/or the registrar signs a transaction on the DLT to remove and/or invalidate the transaction lock.

In one embodiment, the transfer lock is exclusively removed by the investor and the platform and/or registrar does not retain the information necessary to remove and/or unlocking the transfer lock. In one embodiment, the platform and/or registrar removes or restores a transfer lock by executing a function in the locking smart contract that sets the status of the locking record.

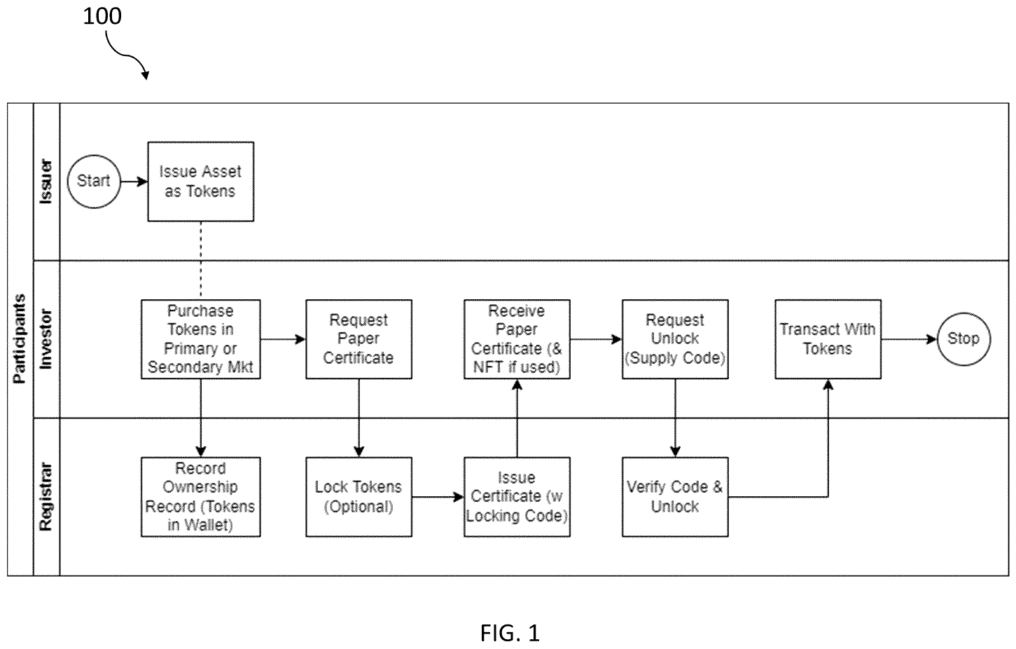

FIG. 1 is a flow diagram of locking and unlocking a digital token by means of a distributed ledger locking mechanism 100 according to one embodiment. In one embodiment, the distributed ledger locking mechanism or “transfer lock” includes a process represented by the arrows in FIG. 1. An asset (preferably a share in a corporation) is issued as an asset token. The asset token is purchased in a primary and/or secondary market. Upon purchase, a record of ownership is memorialized or written onto a DLT. In one embodiment, upon purchase, the asset token is transferred to a digital wallet attributable to the asset token purchaser (or “investor”). In one embodiment, upon purchase of the asset token, a request is made for a paper token certificate. Upon request for a paper token certificate, the asset token is lock (becoming a “protected asset”). The asset token lock (or “transaction lock”) is operable to prevent transfer of the asset token from one digital wallet to another. In one embodiment, a transaction lock is operable to prevent transfer of the asset token despite the digital wallet being compromised or exposed to the public. In one embodiment, the transaction lock is operable to prevent transfer of the asset token despite the private key associated with the digital wallet being compromised. In one embodiment, the transaction lock is operable to reject a transfer of the asset token that includes the private key in the transfer but does not include the unlocking key. In one embodiment, upon locking the asset token, an unlocking code and/or or unlocking key is created. In one embodiment, the unlocking key is a private key generated using standard methods for wallet creation for the DLT hosting the asset. In one embodiment, the unlocking key is a randomly generated string of sufficient length to implement the desired security level. In one embodiment, upon locking the asset token, a certificate is issued that includes the unlocking key. In one embodiment, upon locking the asset token, an unlocking code is created by asymmetrically encrypting the unlocking key with the public key of the investor's digital wallet. In this embodiment, the unlocking code is decryptable using the private key of the investor's wallet, producing the unlocking key. The unlocking key is stored in a plurality of the aforementioned ways. In one embodiment, upon issuance of the certificate, the certificate is transferred to the investor of the protected asset. In one embodiment, an NFT corresponding to the certificate is minted and transferred to a digital wallet associated with the investor. In one embodiment, where the transfer lock is desired to be removed, a request to remove the transfer lock is supplied to the platform and/or registrar. In one embodiment, the request includes the unlocking key. In one embodiment, the unlocking key accompanying the request is compared to the stored unlocking key. In one embodiment, where the unlocking key accompanying the request matches that of the stored unlocking key or resulting hash, the transaction lock is unlocked and the protected asset is able to be transferred to a third-party digital wallet. In one embodiment, prior to the removal of the transaction lock, all requests to transfer the asset token from the investor's digital wallet to a third-party digital wallet are denied. In one embodiment, the request to transfer the asset token is denied and/or prevented despite the private key of the investor's digital wallet being compromised.

FIG. 2A illustrates a logic flow diagram 125 for implementation of a locking mechanism according to one embodiment of the present invention. In one embodiment, the locking mechanism is implemented through a plurality of steps, illustrated by the circled numbers of FIG. 2A. In one embodiment, the locking mechanism involves an operator, who is an entity seeking to have certain digital assets protected (protected assets) and who interacts with the platform of the present invention. In one embodiment, the locking mechanism involves a controller, which represents the entity facilitating the functions of the platform of the present invention. In one embodiment, the operator is an investor of digital assets, or a holder of a digital account through account abstraction. In one embodiment, the controller is the issuer or registrar of securities. In one embodiment, the controller is an administrator of the platform. In one embodiment, the controller is executable code of the platform.

In one embodiment, at step 1, the controller receives a request to lock a protected asset. In one embodiment, the request is to lock an asset already owned. In one embodiment, the request is to purchase a digital asset and lock the digital asset simultaneously. In one embodiment, the platform facilitating the locking mechanism is a hybrid system that includes an off-chain system for receiving locking requests, issuing certificates, and/or delivering certificates, and functionally communicating with on-chain smart contracts for executing locking logic. In one embodiment, the platform facilitating the locking mechanism is a DLT system that includes a plurality of smart contracts for receiving locking requests, issuing certificates, delivering certificates, and/or implementing the locking logic on a DLT. In one embodiment, at step 2, the controller produces an unlocking key. In one embodiment, the unlocking key is a randomly generated string of characters of sufficient length to ensure security. In one embodiment, the unlocking key is a manually generated string of characters of sufficient length to ensure security. In one embodiment, the unlocking key is a digital wallet private key. In one embodiment, at step 3, the controller issues a locking record via the locking logic. In one embodiment, the locking record includes a certificateID (identifying the specific certificate associated with the lock), a protected assetID (identifying the specific asset subject to the lock), a locked walletID (a public key for the operator's externally owned digital wallet), a locking status (indicating a locked or unlocked status stored as a Boolean value), and/or a locking hash (for validation of an unlocking key request). In one embodiment, the locking record includes a plurality of functions indicating which of the protected asset's functions are to be locked by the locking mechanism. In one embodiment, the locking record is issued as an NFT and transmitted to the operator wallet. In one embodiment, at step 4, the controller embeds the unlocking key in a certificate and delivers the certificate to the operator. In one embodiment, the unlocking key is encrypted using asymmetric encryption and the operator's public key to produce an unlocking code. In one embodiment, the unlocking key is decryptable from the unlocking code only with the operator's private key. Advantageously, by applying asymmetric encryption in this way, the delivery of the unlocking key is secure because the private key is needed to decrypt the unlocking key. In one embodiment, the certificate is delivered as a paper share certificate and/or a paper token certificate in an electronic and/or physical form. In one embodiment, at step 5, the operator attempts to operate a function of the protected asset. In one embodiment, the protected asset is an object in which a plurality of functions affecting the object is executed via a smart contract (or a plurality of smart contracts). In one embodiment, the executing functions of the protected assets includes a function of the locking logic that is operable to check for a lock prior to executing other functions of the protected asset. In one embodiment, the locking logic function is always executed prior to execution of any other function affecting the protected asset. Advantageously, by including the locking logic as the first function of the smart contract affecting the protected asset, the operator is assured that the locking status of the protected asset is always assessed prior to any other affecting functions being executed. In one embodiment, the protected asset is a digital token. In one embodiment, the protected asset is a smart contract representing and supporting operations on a fungible and/or non-fungible token. In one embodiment, the protected asset is an account abstraction (i.e., a smart contract that provides a unique digital wallet address that enables interactions with tokens or other smart contracts on a distributed ledger). In one embodiment, the protected asset is any smart contract on a distributed ledger whose functions are to be protected with a locking mechanism. In one embodiment, at step 6, the protected asset attempts to execute the requested function by calling the locking logic's CanOperate function and passing the assetID and requesting walletID in the request. The locking logic then checks for the presence of the locking record, identified by the assetID and walletID, and checks the status of the lock. If no lock exists, if the locking status is set to unlock, and/or no locking record exists, the function returns a status indicating that the operations may continue. If a locking record does exist and the locking status is set to locked, the requested function is blocked. In one embodiment, at step 7, the asset is locked by a locked locking status and the operator executes an unlocking action. In one embodiment, the unlocking action is demonstrated by possession of the unlocking key and results in the locking status of the locking record to be set to unlocked. In one embodiment, the unlocking key is a private key of the operator's externally owned account and/or digital wallet. In one embodiment, the successful signing of any transaction from the operator's externally owned account and/or digital wallet is evidence of possession of the unlocking key. In one embodiment, the operator signs a transaction with the private key via the locking logic to set the locking status to unlocked. In one embodiment, the locking logic sets the locking status to unlocked upon the operator sending the NFT containing the locking record to the controller account and/or controller digital wallet. In one embodiment, the unlocking key is a secure string of characters (letters and numbers) with no relationship to the private key of the operator's wallet. In one embodiment, the controller retains no data related to the unlocking key upon deliver of the certificate. In one embodiment, the operator presents the unlocking key by executing a function to the locking logic. The locking logic then checks a hash of the unlocking key against the locking hash of the locking record and sets the locking status to unlocked upon determination of a correct match of the hashes. In one embodiment, the unlocking key, prior to delivery, is encrypted using asymmetric encryption and the public key of the operator's wallet to produce an unlocking code, which is transmitted and/or delivered to the operator. In one embodiment, the unlocking code is decryptable only with the private key of the operator's digital wallet. The operator decrypts the unlocking code using the private key of the operator's digital wallet to produce the unlocking key. The operator then executes a function to the locking logic including the unlocking key. The locking logic then compares a hash of the unlocking key against the locking hash and sets the locking status to unlocked upon determination of an exact match. In one embodiment, at step 8, the operator attempts to operate a function of the protected asset. In one embodiment, at step 9, the protected assets attempts to execute the requested function by first calling the locking logic's CanOperate function and passing the assetID and requesting walletID in the request. In one embodiment, the CanOperate function includes a functionID, an assetID, and/or a wallet ID to check for lock protection of specific functions. On a response indicating an unlocked status, the protected asset further executes the remaining functions of the request.

FIG. 2B illustrates a logic flow diagram 150 for implementation of a distributed ledger locking mechanism according to one embodiment of the present invention. In one embodiment, the distributed ledger locking mechanism is facilitated through a plurality of steps, illustrated by the circled numbers of FIG. 2B. Steps 1 through 8 represent the process for locking protected assets (i.e., implementing or creating the transfer lock). In one embodiment, at step 1, a protected asset (e.g., a tokenized securities that represents a security, such as stock in a corporation) is issued as a digital token, an asset ID that associated the tokenized asset with the underlying asset is issued, and the tokenized asset includes specific operating logic for the digital token. In one embodiment, the tokenized asset is a digital token and/or a plurality of digital tokens. In one embodiment, the tokenized asset is issued with smart contract logic that includes LockingLogic. The LockingLogic further includes a locking record, which is operable to facilitate the functions of the transfer lock. In one embodiment the operating logic includes a smart contract logical check, called CanOperate. The CanOperate function of the operating logic of the tokenized asset is operable to determine if execution of the operating logic for the digital token is allowed or forbidden. The CanOperate function serves as a “check” because it is operable to check for or determine if a transaction lock exists in relation to the tokenized asset. In one embodiment, the CanOperate function is operable to determine if a locking record exists with a status set to lock prior to executing the remainder of the operating logic (i.e., allow a transfer of the digital token). In one embodiment, the CanOperate function is operable to respond with “true” if the locking status is set to unlock and allows a transfer to occur. In one embodiment, the CanOperate function is operable to respond with “false” if the locking status is set to lock and prevent a transfer from occurring. In one embodiment, the operating logic of the digital token is operable to prevent digital token operations that affect the ownership of the digital token (representing the protected asset) if the CanOperate function returns a false. In one embodiment, the smart contract and/or smart contracts associated with the digital token is operable to include a function to ensure the CanOperate function is called prior to execution of subsequent smart contract logic. In one embodiment, the CanOperate function is the first smart contract logic processed when executing the smart contract associated with the digital token. In one embodiment, the tokenized assets are tokenized using the ERC-20 token standard. In one embodiment, the CanOperate function is implemented into the ERC-20 digital token standard. In one embodiment, the CanOperate function is implemented before, and is executed before, the ERC-20's transfer and transferFrom functions. In one embodiment, the tokenized securities are tokenized using the Ethereum Request for Comment 721 (ERC-721) token standard and the CanOperate function is implemented before, and executed before, the ERC-721's transferFrom and safeTransferFrom functions.

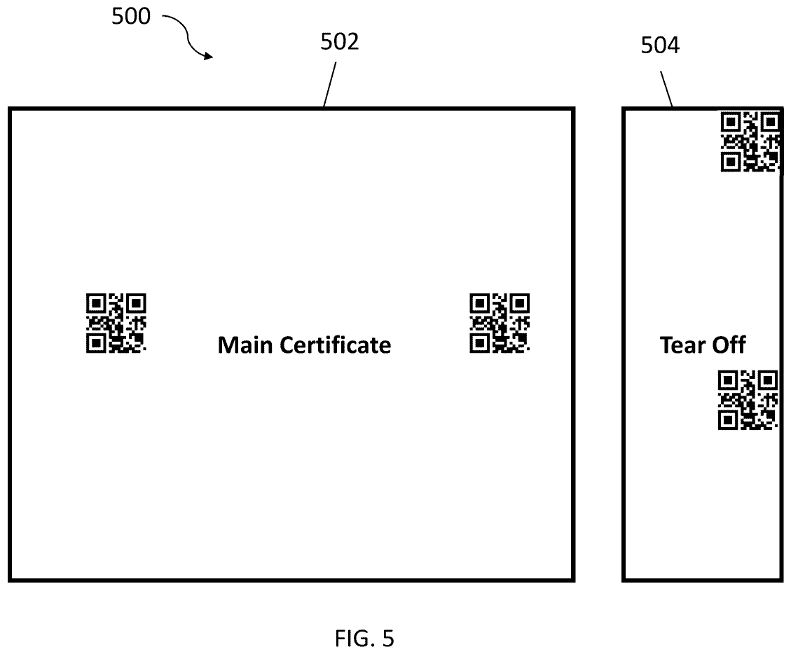

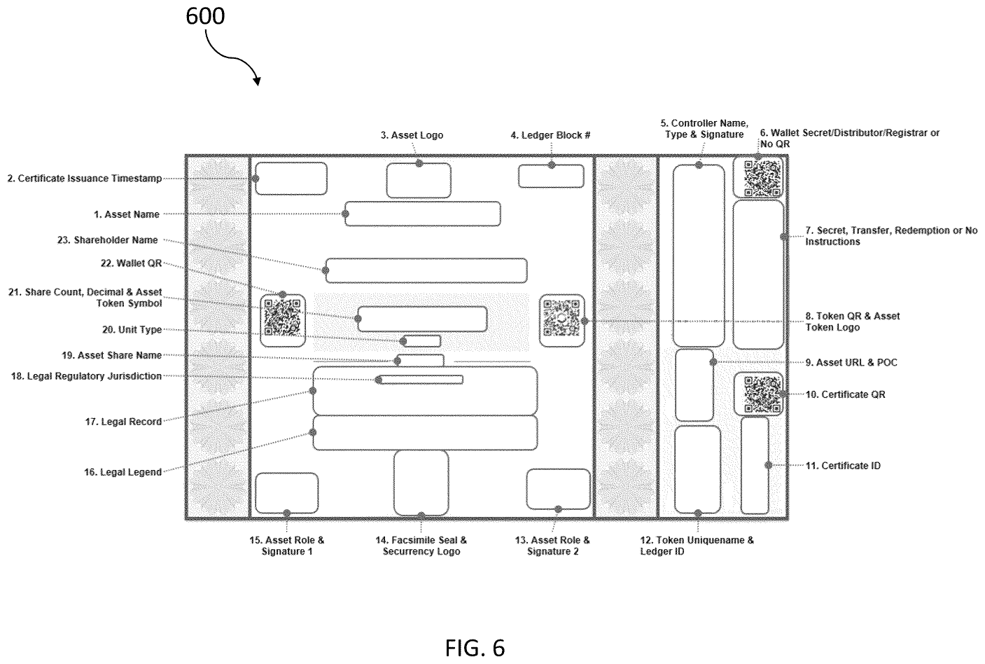

In one embodiment, at step 2, the investor (or purchaser of the tokenized asset) is provided, by the platform, a public key and private key pair associated with the tokenized asset and used to perform cryptographic operations. In one embodiment, at step 3, the platform and/or the registrar associated with the underlying asset of the tokenized asset is operable to produce a certificate identification (ID) (CertID in FIG. 2B) that represents the investor's ownership right in the tokenized asset. In one embodiment, at step 4, the platform and/or the registrar is operable to produce an unlocking key (K in FIG. 2B) associated with the transaction lock. In one embodiment, the unlocking key is a randomly generated string of characters of a sufficient length to ensure proper security. In one embodiment, at step 5, a hash algorithm is used to combine the certificate ID and the unlocking key to produce a locking hash (K #CertID in FIG. 2B). In one embodiment, the platform is operable to produce the locking hash by combining the characters that make up the certificate ID and the unlocking key and applying a hash algorithm to the character combination. In one embodiment, the hash algorithm is Secure Hash Algorithm 3 (SHA-3) or other similar secure hashing algorithm. In one embodiment the platform and/or registrar does not retain the unlocking key. In one embodiment, at step 6, the platform and/or the registrar is operable to produce an unlocking code (K* in FIG. 2B) by asymmetrically encrypting the unlocking key with the public key associated with the digital wallet of the investor. In one embodiment, the asymmetric encryption method is an elliptic-curve cryptography (ECC) method. In one embodiment, the unlocking code is only decryptable by using the digital wallet's private key to produce the unlocking key. The unlocking code, K* is an asymmetric encryption of the unlocking key, K, where the investor's public key is used to encrypt the unlocking key and the investor's private key is used to decrypt the unlocking code. In one embodiment, at step 7, the platform and/or the registrar publishes the unlocking code to the investor. In one embodiment, at step 7, the platform and/or the registrar publishes the unlocking key to the investor. In one embodiment, the platform and/or the registrar publishes the unlocking code and/or the unlocking key through the certificate of FIGS. 5 and 6. In one embodiment, upon publishing the unlocking code the platform and/or registrar does not retain a copy of the unlocking key. In one embodiment, upon publishing the unlocking code the platform and/or registrar destroys all traces of the unlocking key from its records. In one embodiment, the unlocking code and/or unlocking key is encrypted into the QR code of the certificate. In one embodiment, the unlocking code and/or unlocking key is sent to the investor in a plurality of secure methods known in the art (API, letter, email, etc.). In one embodiment, the unlocking code and/or the unlocking key is published using a paper token certificate. In the preferred embodiment, the unlocking code (K* in FIG. 2B) is published using a paper token certificate. In one embodiment, the unlocking code and/or the unlocking key is published using an NFT and transferring it to the digital wallet of the investor. In one embodiment, the NFT represents the paper token certificate. In one embodiment the NFT associated with the locking record is published on a DLT. In one embodiment, at step 8, the platform and/or the registrar is operable to call the operating logic of the tokenized asset to issue a locking record as an NFT. In one embodiment, the locking record is operable to set the status of the tokenized asset, through the CanOperate function, to locked, such that operations affecting the ownership of the tokenized security are prevented. In one embodiment, the NFT associated with the locking record is viewable on a distributed ledger. In one embodiment, the NFT associated with the locking record includes the asset ID, the public key of the digital wallet associated with the investor, the locking hash, and the locking status (either locked or unlocked for transfer).

Advantageously, the information posted through the NFT associated with the locking record is of no operating value to any onlookers (i.e., onlookers cannot transfer the tokenized securities with the information posted through the NFT) because the locking key can only be produced through decryption of the unlocking code (using the private key of the digital wallet through asymmetric encryption). In one embodiment, while the transfer lock is in place through the process previously described, any attempt to transfer the tokenized asset through the operating logic of the tokenized securities will be prevented due to the CanOperate's function of checking for a transfer lock, resulting in the tokenized asset become a “protected asset.” In one embodiment, following an attempt to transfer the tokenized asset while a transfer lock is in place, the operating logic of the tokenized securities will execute CanOperate, which will determine that there is a transfer lock associated with the tokenized asset (i.e., a locked status) and reject and/or prevent further ownership operations.

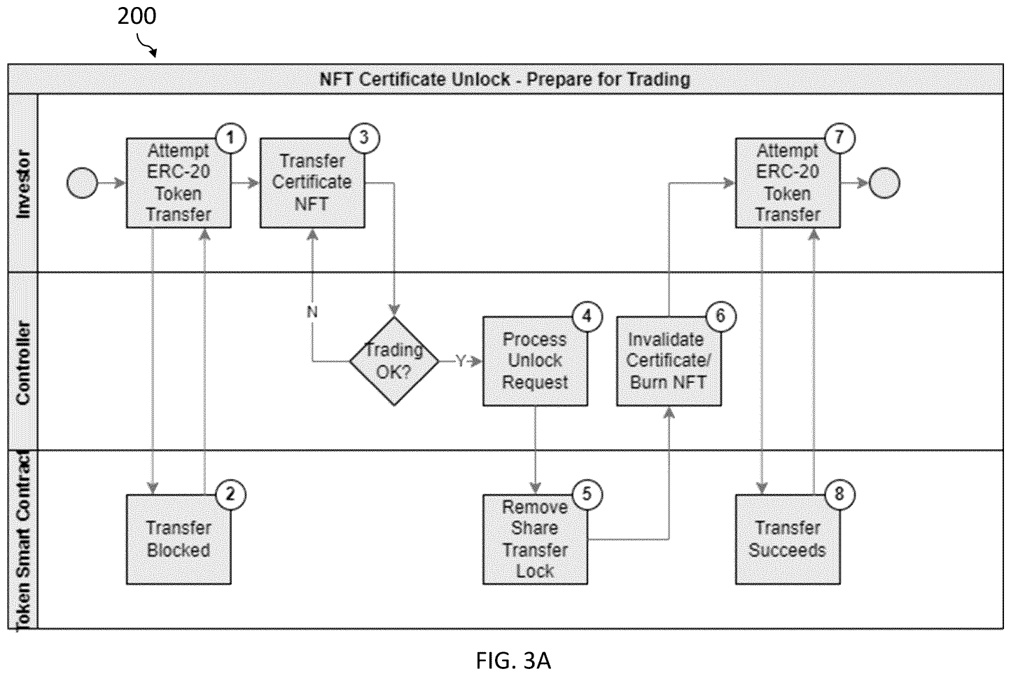

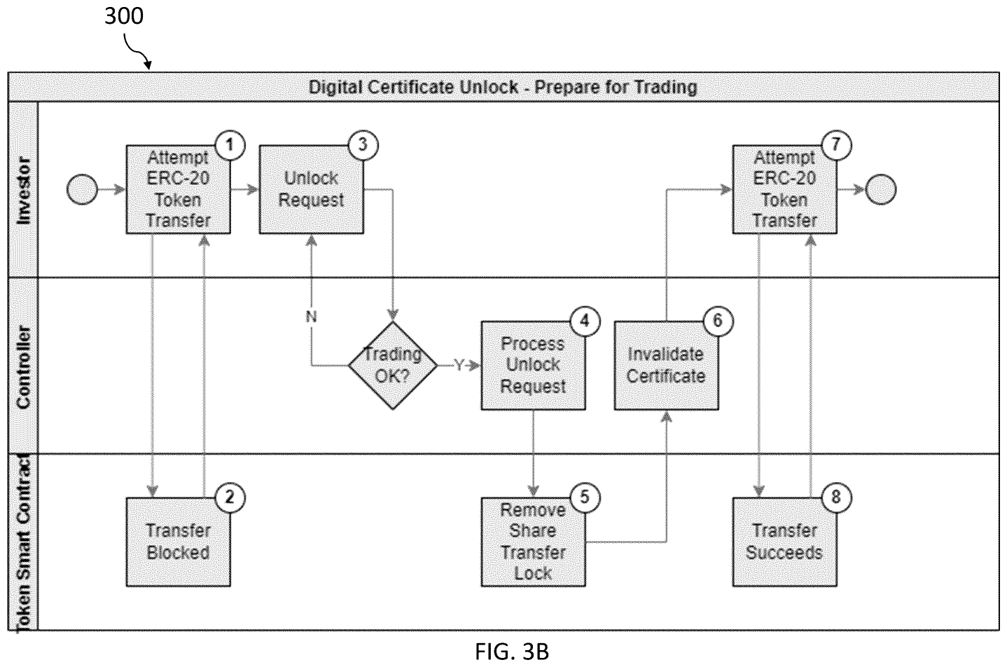

Steps 9 through 12 of FIG. 2B represent the process of unlocking protected assets following the creation and/or implementation of the transfer lock. In one embodiment, at step 9, a request key (K1 in FIG. 3), operable to unlock the tokenized asset for transfer (or other ownership function), is produced by decrypting the unlocking code using the private key associated with the digital wallet of the investor. In one embodiment, at step 9, a request key is produced using the private key associated with the digital wallet of the investor and the unlocking code. In one embodiment where the platform publishes the locking key to the investor, the investor need only provide the locking key, rather than having to decrypt the unlocking code to produce the request key. In one embodiment, at step 10, an UnlockingRequest function of the operating logic of the protected asset is execute by providing the request key and the certificate ID. In one embodiment, at step 11, the locking logic of the operating logic of the tokenized asset is operable to produce an unlocking hash (K1 #CertID) by applying a hash algorithm to the request key and certificate ID (provided through the UnlockingRequest function). In one embodiment, the platform is operable to produce the unlocking hash by combining the characters that make up the certificate ID and the requesting key and applying a hash algorithm to the character combination. In one embodiment, the hash algorithm is SHA-3 or other similar secure hashing algorithm. The platform is operable to change the locking status of the protected asset to unlocked if the unlocking hash (K1 #CertID) matches the locking hash (K #CertID), resulting in the tokenized asset no longer being “protected” (i.e., free for transfer). In one embodiment, the locking status is altered by the LockingLogic of the smart contract associated with the tokenized asset. In one embodiment, at step 12, following a correct match of the unlocking hash and the locking hash, execution of the operating logic of the tokenized securities will call the CanOperate logic, which will produce “true” allowing ownership transactions to occur.

In one embodiment, the platform provides a means to remove the transaction lock. In one embodiment, at step 13, the platform and/or the registrar executes a RemoveLock(CertID) function by calling the LockingLogic of the transfer lock and specifying the locking record associated with the locking status of the tokenized securities. However, the preferred embodiment does not include this functionality to ensure that the registrar (or anyone) does not hold the ability to remove the transfer lock, rather the ability to unlock the transfer lock remains with the investor.

Advantageously, in order to unlock the transfer lock, a user requires both the digital wallet's private key and unlocking code of the paper token certificate. Therefore, in the event of a private key compromise, the investor's tokenized securities are safe from transfer because the unlocking code of the paper token certificate is also needed to remove the transfer lock. This encompasses the objective of applying a physical security measure to mitigate the cyber security risk of managing digital assets. Due to the embodiment where the certificate is published as a physical paper certificate (as illustrated in FIGS. 5 and 6), an investor is able to provide physical safety measures (e.g., placing the paper certificate in a safe deposit box, safe, or under their mattress) to ensure the safety of their digital assets. Additionally, in the embodiment where the platform and/or registrar does not retain a data record of the unlocking key and/or the unlocking code, the investor can be assured that even in the event of a data breach of the platform or registrar, their digital assets are safe because they are the only one with access to the unlocking key (through decryption of the unlocking code).

FIG. 3A is a flow diagram of unlocking a digital token by means of a distributed ledger locking mechanism utilizing an NFT 200 according to one embodiment. In one embodiment, where a transfer of an asset token tokenized according to an ERC-20 standard subject to a transfer lock, initiates a transfer, the transfer is blocked, prevented, and/or denied. In one embodiment, an unlocking request is submitted by transfer of an NFT of the paper token certificate to the digital wallet of the platform and/or registrar. In other embodiments, the transaction lock is removed by presenting a valid unlocking key to the registrar or unlocking logic of the platform. In one embodiment, the unlocking request is processed by a controller. In FIGS. 2 and 3, the controller is the mechanism that records the locking state of a protected asset. In one embodiment, the controller is an off-chain or manual process implemented by the registrar. In one embodiment, the controllers is on-chain locking logic which maintains the locking record. In one embodiment, the controller is a manual or off-chain process implemented by the registrar and/or the platform. In one embodiment, the controller is operable to compare the unlocking key and/or unlocking code of the unlocking request with that of the known unlocking key, unlocking code, or locking record hash. In one embodiment, the controller is operable to maintain the transaction lock and/or remove the transaction lock based upon the comparison of request unlocking key and known unlocking key. In one embodiment, the controller is operable to maintain the transaction lock and/or remove the transaction lock based upon the comparison of a hash of the request unlocking key and a hash of the known unlocking key. In one embodiment, where the comparison indicates that the request unlocking key and the known unlocking key are the same, the paper token certificate is invalidated and the NFT of the paper token certificate is burned. In one embodiment, following the correct match of unlocking keys and/or a removal of the transaction lock, any subsequent attempt to transfer the asset token is allowed to proceeds.

FIG. 3B is a flow diagram of unlocking a digital token by means of a distributed ledger locking mechanism utilizing a paper token certificate 300 according to one embodiment. In one embodiment, where a transfer of an asset token tokenized according to an ERC-20 standard subject to a transfer lock, initiates a transfer, the transfer is blocked, prevented, and/or denied. In one embodiment, an unlocking request is submitted by API. In one embodiment, the unlocking request is processed by a controller. The controller is operable to compare the unlocking key and/or unlocking code of the unlocking request with that of the known unlocking key and/or unlocking code. The controller is operable to maintain the transaction lock and/or remove the transaction lock based upon the comparison of request wallet secret and known wallet secret. In one embodiment, the controller is operable to maintain the transaction lock and/or remove the transaction lock based upon the comparison of a hash of the request unlocking key and a hash of the known unlocking key. In one embodiment, where the comparison indicates that the request unlocking key and the known unlocking key are the same, the paper token certificate is invalidated. In one embodiment, following the correct match of wallet secrets and/or a removal of the transaction lock, any subsequent attempt to transfer the asset token is allowed to proceed.

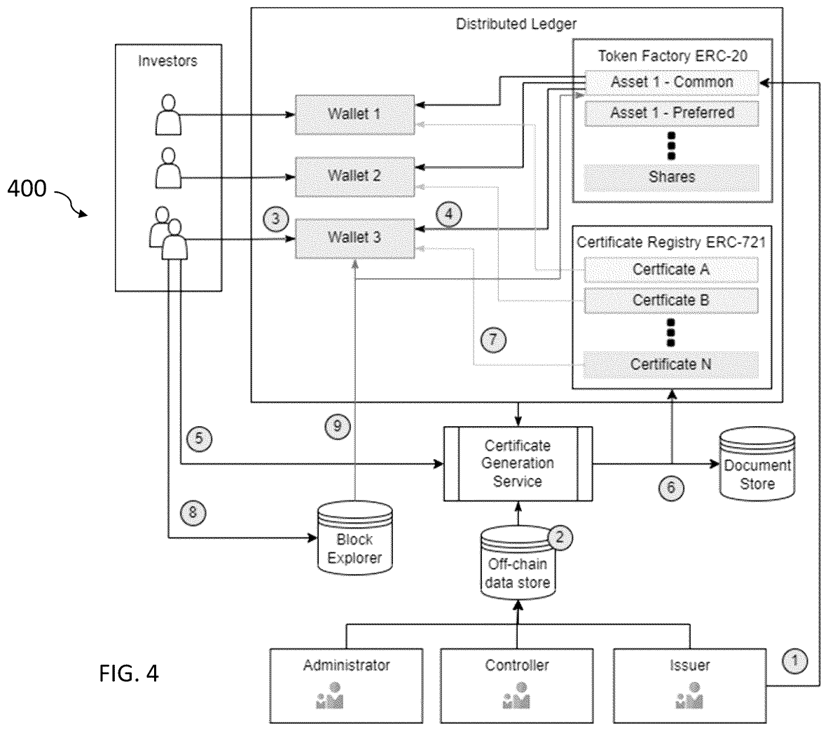

FIG. 4 illustrates a schematic diagram of a locking mechanism architecture according to one embodiment. In one embodiment, the transfer lock is facilitated by the computer system 400 illustrated in FIG. 4. In one embodiment, the computer system 400 illustrated in FIG. 4 is the platform described in the present application. In one embodiment, the platform includes a token factory, operable to create the digital tokens that are the protected assets as described in the present application. In one embodiment, the token factory is operable to issue digital tokens with the locking logic of FIG. 2B. In one embodiment, the platform includes a certificate registry is operable to implement the functions and enforce the operations of the locking logic as described in the present disclosure. In one embodiment, the platform includes a plurality of certificates, represented by certificate A, certificate B, and certificate N of FIG. 4. In one embodiment, the plurality of certificates are the locking records as described in the present application. In one embodiment, the certificate registry is operable to issue a plurality of certificates. In one embodiment, the certificate registry is operable to execute a plurality of locking records on a DLT. FIG. 4 further illustrates a plurality of investors associated with a plurality of digital wallets as described in the present application. In one embodiment, the platform includes a block explorer, operable to search for real-time and historical information about the DLT associated with the transfer lock. In one embodiment, the platform includes a certificate generation service, operable to create the paper token certificate, the certificate NFT, and/or other electronic certificates described in the present application. In one embodiment, the platform includes a document store, operable to store the certificates. In one embodiment, the platform includes and/or is in functional communication with an off-chain data store, which is a off-chain database as described in the present application. In one embodiment, the platform includes a plurality of administrators, including an administrator, a controller, and the registrar (illustrator in FIG. 4) as described in the present application.

FIG. 5 illustrates a diagram of a paper token certificate 500 according to one embodiment. While FIG. 5 illustrates a specific example of a paper token certificate, one of ordinary skill in the art will appreciate that the paper token certificate can be published in a plurality of ways. One of ordinary skill in the art will appreciate that the paper token certificate serves as a medium for publishing the unlocking code and/or unlocking secret to the investor and that such a medium may come in a plurality of forms. In one embodiment, the paper token certificate includes a main certificate 502 and a tear-off certificate 504. In one embodiment, the main certificate 502 and the tear-off certificate 504 are removably attached to one another. In one embodiment, the main certificate 502 includes relevant information of the underlying protected asset, the corporation to which the asset pertains, and/or other relevant information on the investor's interest in the corporation. In one embodiment, the tear-off certificate 504 includes a QR code of the unlocking code related to the transfer lock. In one embodiment, the tear-off certificate 504 includes instructions on how to decrypt the unlocking code to produce the unlocking key. In one embodiment, the tear-off certificate 504 includes instructions on how to submit the unlocking key for unlocking of the transfer lock. In one embodiment, the tear-off certificate 504 includes a QR code of the unlocking key. In one embodiment, the tear-off certificate 504 includes information pertinent to the unlocking, the transaction lock, and/or the process for removing the transaction lock. The paper token certificate's tear-off certificate 504 enables the additional security measure of the present invention. Due to the physical nature of the tear-off certificate 504

FIG. 6 illustrates a diagram of an issued paper token certificate 600 according to one embodiment. In one embodiment, the issued paper token certificate 600 includes a plurality of information sections, operable to display pertinent information to the paper share certificate, underlying asset, digital token, relevant DLT, and/or transaction unlocking/locking procedures. In one embodiment, the issued paper token certificate includes an asset name, a certificate issuance timestamp, an asset logo, and/or ledger block number, a controller name, type, and/or signature, a unlocking code/unlocking QR code, wallet secret transfer instructions, an asset token QR code, an asset URL, a certificate QR code, a certificate identification (ID) number, a ledger ID, a plurality of corporation role signatures, a facsimile seal, a legal legend, a legal record, a regulatory jurisdiction information field, an asset share name field, a unit type, a share count and token symbol field, a wallet QR code, and/or a shareholder name. In one embodiment, the wallet secret/unlocking QR is the wallet secret necessary to lift the transaction lock.

In one embodiment, the platform is in functional communication with at least one DLT, blockchain, and or Ethereum ledger through at least one smart contract. In one embodiment, the transaction described in the present application are affected by digital wallets as described in the present application. In one embodiment, the locking mechanism are executed via at least one smart contract on a DLT. In one embodiment, the locking mechanisms are executed via the locking logic smart contracts. In one embodiment, the unlocking code is stored on-chain through at least one smart contract.

In one embodiment, the platform is in functional communication with and/or includes at least one internal and/or external database. In one embodiment, the unlocking key and/or unlocking code is stored in a database and verification of the unlocking key and/or unlocking code is accomplished manually. However, in the preferred embodiment, all of the data associated with the locking mechanism except the unlocking code and/or the unlocking key is stored on a DLT. In the preferred embodiment, the unlocking code and/or unlocking key is stored in a secure physical location of the investor's choosing.

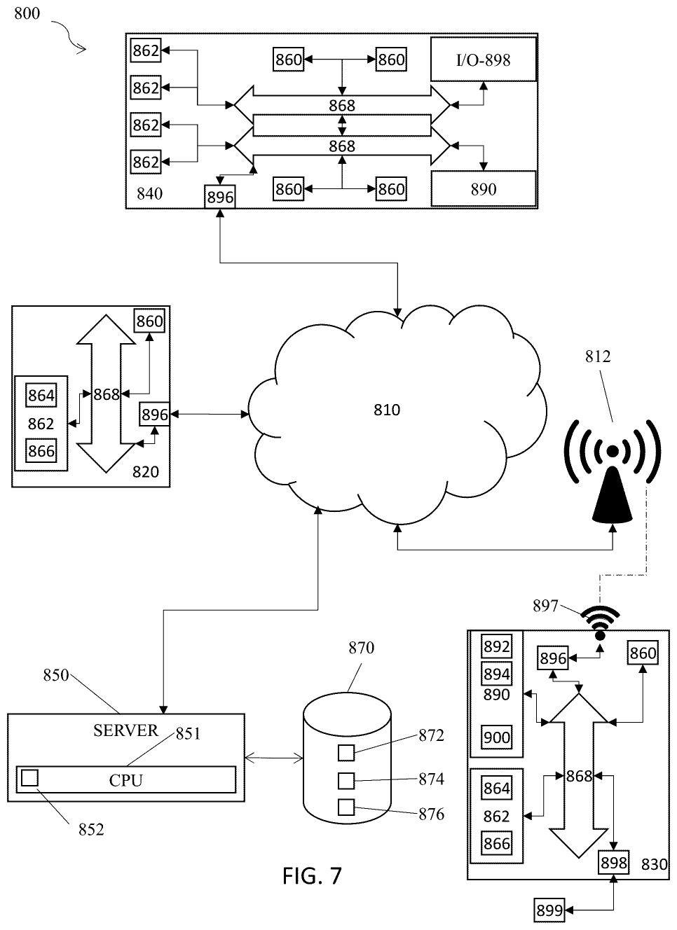

FIG. 7 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 7, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 7, is operable to include other components that are not explicitly shown in FIG. 7, or is operable to utilize an architecture completely different than that shown in FIG. 7. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougayar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, DP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method for locking a digital asset in a digital wallet comprising:
a platform including a processor and a memory receiving a locking request to lock the digital asset;
the platform implementing locking logic and recording a locking record on a ledger;
wherein the locking logic is operable to prevent execution of functions affecting the digital asset while the digital asset is locked;
wherein the locking record is an entry on the ledger;
the platform issuing an unlocking key for unlocking the digital asset;
the platform cryptographically hashing the unlocking key to produce a locking hash and recording the locking hash on the locking record;
the platform asymmetrically encrypting the unlocking key with a public key associated with the digital wallet holding the digital asset to produce an unlocking code;
the platform delivering the unlocking code via a certificate;
wherein the unlocking code is decryptable with a private key associated with the digital wallet holding the digital asset to produce the unlocking key;
the platform receiving an unlocking request to unlock the digital asset;
wherein the unlocking request to unlock the digital asset includes an unlocking key;
the platform cryptographically hashing the unlocking key of the unlocking request to produce an unlocking hash;
the platform comparing the unlocking hash to the locking hash on the locking record;
upon matching the unlocking hash to the locking hash, the platform unlocking the digital asset; and
wherein unlocking the digital asset causes the locking logic to allow execution of functions affecting the digital asset while the digital asset is unlocked.

2. The method of claim 1, wherein the locking logic does not affect execution of functions for additional digital assets in the digital wallet.

3. The method of claim 1, wherein the unlocking key is included in a Quick Response (QR) code.

4. The method of claim 1, wherein the locking request and/or the unlocking request is received through an Application Programming Interface (API).

5. The method of claim 1, wherein the certificate is a paper token certificate including a Quick Response (QR) code of the unlocking key and/or the unlocking code.

6. The method of claim 1, wherein the platform issuing the unlocking key for unlocking the digital asset includes minting a non-fungible token (NFT) corresponding to the certificate and transferring the NFT to the digital wallet.

7. The method of claim 6, wherein the unlocking request includes a transfer of the NFT from the digital wallet to the platform and the transfer further includes the unlocking key, wherein the NFT does not include the unlocking key.

8. The method of claim 1, wherein the locking logic is enforced by a locking script, a smart contract, and/or a modified transfer function of a smart contract associated with the digital asset.

9. The method of claim 1, wherein the locking record includes a locking status of the digital asset.

10. The method of claim 9, wherein the digital asset include a smart contract function to check the locking status of the digital asset prior to executing smart contract functions.

11. The method of claim 1, further comprising preventing execution of functions affecting the digital asset upon comparing the unlocking hash to the locking hash of the locking record and not matching the unlocking hash to the locking hash.

12. The method of claim 1, wherein the ledger includes a Distributed Ledger Technology (DLT), public distributed ledger, a private distributed ledger, and/or a hybrid ledger.

13. A system for applying a locking check on a digital asset comprising:
a platform including a processor and a memory;
wherein an unlocking key is generated using an unlocking code by asymmetrically encrypting an unlocking code with a private key associated with a digital wallet holding the digital asset;
wherein the platform is operable to receive an unlocking request to unlock the digital asset including the unlocking key;
wherein the platform is operable to implement locking logic to check a status of a locking record associated with the digital asset to determine the status of the locking record of the digital asset is locked;
wherein the status of the locking record associated with the locked digital asset must be unlocked prior to execution of functions affecting the locked digital asset;
wherein the platform is operable to cryptographically hash the unlocking key of the unlocking request to produce an unlocking hash;
wherein the platform is operable to compare the unlocking hash to a locking hash on the locking record;
wherein the platform is operable to determine a match of the unlocking hash to the locking hash, and unlock the digital asset; and
wherein unlocking the digital asset causes the locking logic to allow execution of functions affecting the digital asset while the digital asset is unlocked.

14. The system of claim 13, wherein the platform is operable to receive a locking request to lock the digital asset, implement the locking logic, and record a locking record on a distributed ledger.

15. The system of claim 13, wherein the platform is operable to cryptographically hash the unlocking key to produce a locking hash and record the locking hash on the locking record.

16. The system of claim 13, wherein the platform is operable to asymmetrically encrypt the unlocking key with a public key associated with the digital wallet holding the digital asset to produce the unlocking code.

17. The system of claim 13, wherein the platform is operable to deliver the unlocking code via a certificate, wherein the unlocking code is decryptable with the private key associated with the digital wallet holding the digital asset to produce the unlocking key, wherein the certificate is a paper token certificate including a Quick Response (QR) code of the unlocking key and/or the unlocking code, wherein the locking logic is operable to prevent functions from affecting the digital asset while the digital asset is locked, and wherein the locking logic does not affect execution functions affecting additional digital assets in the digital wallet not subject to the locking check.

18. A system for applying a locking check on a digital asset comprising:
a platform including a processor and a memory;
wherein an unlocking key is generated using an unlocking code by asymmetrically encrypting an unlocking code with a private key associated with a digital wallet holding the digital asset;
wherein the platform is operable to receive a request to unlock the digital asset including the unlocking key;
wherein the request to unlock the digital asset includes a transfer of a Non-Fungible Token (NFT) of a certificate and the unlocking key to a digital wallet of the platform;
wherein the platform is operable to implement locking logic to check a status of a locking record associated with the digital asset to determine the status of the locking record of the digital asset is locked;
wherein the platform is operable to mint a NFT corresponding to the locking record;
wherein the status of the locking record associated with the locked digital asset must be unlocked prior to execution of functions affecting the locked digital asset;
wherein the platform is operable to cryptographically hash the unlocking key of the unlocking request to produce an unlocking hash;
wherein the platform is operable to compare the unlocking hash to a locking hash on the locking record;
wherein the platform is operable to determine a match of the unlocking hash to the locking hash, and unlock the digital asset; and
wherein unlocking the digital asset causes the locking logic to allow execution of functions affecting the digital asset while the digital asset is unlocked.

19. The system of claim 18, wherein the locking logic is enforced by a locking script, a smart contract, and/or a modified function of a smart contract associated with the digital asset.

20. The system of claim 18, wherein the locking logic is operable to prevent a transfer of the digital asset, wherein the transfer includes the private key associated with the digital wallet holding the digital asset while the digital asset is locked, and wherein locking record includes a locking status of the digital assets.
